(19) United States
(12) Patent Application Publication
(10) Pub. No.: US 2026/0221483 A1
(43) Pub. Date: Jul. 30, 2026

(54) REDOX FLOW BATTERY SYSTEM AND STACK THEREOF

(71) Applicant: CMBlu Energy AG, Alzenau (DE)

(72) Inventors: Ulrich STIMMING, Oberaudorf (DE); Marc Henning DIEKMANN, Graefelfing (DE); Fahimeh SHAHVARANFARD, Kolbermoor (DE)

(21) Appl. No.: 19/148,077

(22) PCT Filed: Jan. 17, 2024
(86) PCT No.: PCT/EP2024/050953

§ 371 Date: Jul. 15, 2025

(30) Foreign Application Priority Data
Jan. 17, 2023 (DE) 10 2023 100 990.7

(51) Int. Cl. H01M 8/18; H01M 4/90; H01M 8/0258; H01M 8/04082; H01M 8/24

(52) U.S. Cl. CPC H01M 8/188; H01M 4/9041; H01M 8/0258; H01M 8/04201; H01M 8/24

(57) ABSTRACT

We describe a redox battery unit cell, comprising: a first electrode, a second electrode spaced apart from the first electrode, and a membrane arranged between the first and the second electrode, wherein the first electrode comprises a first flow field.

### TECHNICAL FIELD

The present disclosure generally relates to a redox battery unit cell and a redox battery cell stack.

### BACKGROUND

Using renewable energies such as solar and wind requires an energy management that contains energy storage capabilities. Redox flow batteries (RFBs) are an option that can be used in decentralized as well as in centralized systems. RFBs are the only is type of battery in which the energy content and the power output can be scaled independently, offering a high flexibility for applications such as load levelling and frequency stabilization.

The current technology, the all-vanadium RFB, has clear advantages but suffers from distinct problems, the low energy density (about 20 times lower than Li-ion batteries) and low specific power density which requires high surface area felt electrodes to mitigate this problem. Complex ions with multiple redox centers (for higher energy density) and high rates of electron transfer (for high power density) could provide an alternative approach to this established system. These complex ions necessitate, however, profound structural and chemical analysis and redesign of the redox system and the assembled stacks consisting thereof.

Redox flow batteries (RFBs) are one of the few options to store energy from intermittent renewable energy sources such as wind and solar. While the concept of RFBs itself is very elegant, as it allows for independent scaling of energy and power content, the community has not yet decided on a universal battery chemistry. Currently, there are in principle two schools of thought: The first group advocates dissolved transition metal ions (e.g. Fe²⁺/Fe³⁺, V²⁺/V³⁺), transition metal oxyanions (e.g. VO²⁺/VO₂⁺) or transition metal complexes (e.g. [Fe(CN)₆]⁴⁻/[Fe(CN)₆]³⁻) as electron carriers (all three will be called metal ions for simplicity), while the second proposes to employ organic redox active materials. Both approaches come with their distinct advantages and drawbacks. A prominent redox couple of the dissolved metal chemistries is the all-vanadium redox flow battery (VRFB). Utilizing four oxidation states of vanadium (V²⁺, V³⁺, VO²⁺, VO₂⁺) this cell chemistry has the advantage that cross-over of species from one half-cell through the separator into the other half-cell does not lead to a chemical contamination and the cell can be rebalanced electrochemically.

The main drawbacks of the VRFB are the sluggish kinetics of the V²⁺/V³⁺ and the VO²⁺/VO₂⁺ redox reactions which limit the current density and therefore the power density. While there is a debate in the literature about the correct electron rate constant k₀ for the vanadium reactions and about which half-cell is faster, it is on the order of k₀=10⁻⁶ cm s⁻¹.

Organic redox couples can be low cost and made from abundant elements, and they offer greater variability than metal ion redox couples due to their tunable structure. A great number of organic redox couples have been presented in recent years. However, as most studies have been restricted to laboratory cell operation, insights into scale-up with larger cell areas, bigger electrolyte volumes and long-term cycling are currently not available.

Another type of redox electrochemistry that can be employed in RFBs uses polyanionic ions such as polyoxometalates (POMs). POMs form a class of discrete transition metal-oxide nanoclusters. They are prepared from metals, but offer high structural diversity and therefore versatile electrochemistry.

POMs as electrolyte in RFBs provide significant chemical and/or electrochemical advantages over the known vanadium system such as:
1. Electrons added to POMs by reduction are often delocalized over several metal atoms, and this will facilitate fast electron transfer which enables high current densities;
2. POMs are anions and are bigger than solvated transition metals. Therefore, POMs should not permeate through ion exchange membranes typically employed in RFBs;
3. Electron transfer by POMs is often coupled to cation or proton transfer. Therefore, the net charge of the polyoxoanions does not change upon oxidation or reduction. This concept, often found in biological systems, avoids highly charged species and results in increased stability;
4. Some POMs are highly soluble, with the maximum concentration determined by the kind of POM, the electrolyte and also the present counterions. Coupled with multi-electron transfers per molecule this can lead to high energy densities.

Furthermore, as each POM as reduction-oxidation species ion of the electrolytes, when used in a redox cycle such as a redox flow battery, is capable of transferring multiple electrons, more efficient charging and discharging and a greater stored charge density is possible than with conventional vanadium ion-based flow batteries. Additionally, the lower charge-transfer resistance of the polyoxometalate (POM) electrolytes as compared to vanadium electrolytes increases voltage efficiency and increases the power density.

POM electrolytes comprise large reduction-oxidation species ions, which exhibit slower permeation through the membrane than vanadium ions, which reduces self-discharge of the flow battery.

However, the particular reduction-oxidation properties, such as the increased charge-transfer rate or the charge density precludes energy efficient implementation of these novel electrolyte types comprising reduction-oxidation species ions of comparable charge transfer properties into state-of-the-art redox flow batteries.

### SUMMARY

The inventors have realized the need for an improved redox battery unit cell, wherein, in particular, the energy storage potential of reduction-oxidation species such as POMs and reduction-oxidation species of comparable charge transfer properties can be fully utilized.

In one aspect according to the present disclosure, there is provided a redox battery unit cell. The redox battery unit cell according to the present disclosure comprises:
a first electrode,
a second electrode spaced apart from the first electrode, and
a membrane arranged between the first and the second electrode,
   wherein the first electrode comprises a first flow field.

As an example, the redox battery unit cell may be used to convert electrical energy generated in a renewable energy system to chemical energy that can be stored until a later time at which there is demand for the electrical energy. The redox battery unit cell may then convert the chemical energy into electrical energy for supply to an electric grid, an electrical vehicle etc.

In this aspect, the redox battery unit cell comprises a first electrode, a second electrode which is spaced apart from the first electrode and a membrane arranged between the first and the second electrode. The term “electrode” as used herein generally refers to a physical object (such as a solid or fluid) capable of taking an electric current to or from a source of power. That is, the term “electrode” as used herein can refer to an electron-providing or electron-removing, i.e. an electron-conducting solid but also to an electron-conducting fluid. The redox battery unit cell as defined in claim 1 can thus be characterized in that the first electrode and the second electrode both comprise solid structures. The redox battery unit cell as defined in claim 1 can thus alternatively be characterized in that the first electrode comprises a solid structure and wherein the second electrode comprises a fluid, such as a gas (preferably comprising air and/or oxygen) in contact with a second solid (e.g. metal) electrode. That is, if the second electrode comprises for example oxygen, the oxygen can participate in an electrochemical reaction with protons provided via the membrane and electrons provided via the charge collector to the second solid electrode in a two-electron process producing water. Optionally, the second electrode consists of a fluid, such as a gas, preferably of air and a second solid electrode in contact with the fluid. That is, the electrons provided from the first electrode during discharging can react with a fluid or a gas at the second electrode.

The second electrode is spaced apart from the first electrode such that short-circuit faults and tunneling current are avoided. That is, the second electrode is not in direct contact with the first electrode but spatially separated from the first electrode. The first and second electrode can be spatially separated for example by a distance (inner electrode distance) of greater than 1 mm. For example, the inner electrode distance can be in the range from 1 mm to 1 cm, or from 2 mm to 100 mm, or from 4 mm to 50 mm. Preferably, the inner electrode distance is from 10 to 25 mm.

The first and second electrode are separated such that short-circuit faults and tunneling current are avoided. In addition to the spatial separation, the first and second electrode are furthermore separated by a membrane, which is arranged between the first and the second electrode. The membrane acts as (electronical) separator of the first and second electrode. The membrane allows transport of ionic charge carriers that are needed to close the circuit during the charging/discharging of the battery.

The first electrode comprises a first flow field to operate the redox battery unit cell efficiently. The term “flow field” as used herein may refer to a space or a region where a fluid, such as a liquid electrolyte, is distributed by introducing said fluid into a physical structure in order to adequately provide said fluid to the desired position of the electrode. The flow field of the first electrode generally serves essentially important multiple functions, including as current collectors to provide electrical continuity in the redox battery unit cell electrodes and e.g. charge collectors coupled thereto.

Furthermore, the flow field can also act as mechanical support for the membrane electrode assembly (MEA) comprising the first electrode, the second electrode and the membrane arranged between the first and second electrode, as well as for distributing the electrolyte. It is for example well-known that the performance of a fuel cell is highly dependent on the efficient transport and uniform distribution of the reactants to the electrode catalysts, and on the appropriate water management of the fuel cell, i.e. the supply and removal of water produced during operation of the fuel cell. Similarly, flow field design greatly affects the redox battery unit cell performance by controlling the electrolyte gradient, flow rate, pressure drop, water distribution, and current density profile as well as reduction-oxidation species utilization efficiency at the electrode. Therefore, by providing a redox battery unit cell comprising a first electrode, wherein the first electrode comprises a first flow field, the redox battery unit cell according to the present disclosure provides a unit cell, which is adaptable to a wide range of reduction-oxidation species used in the redox electrolyte. By including a flow field into the first electrode, higher current and thus power densities can be achieved in comparison to traditional electrodes having no flow field in the electrode, while the battery device can be structurally simplified and thus improving its reliability and durability.

In some examples, multiple repetitions of the electrode having a flow field/membrane/electrode unit cell may be considered to be a cell unit and may be used in a stacked arrangement.

In some examples, the second electrode of the redox battery unit cell comprises a (second) flow field.

Similar to the first electrode, also the second electrode can comprise a second flow field. The second flow field of the second electrode is generally provided for the technical effects as discussed for the first electrode above. By providing also the second electrode with a flow field (i.e. second flow field), the versatility of the redox battery unit cell can be further increased by allowing the energy efficient combination of a greater number of possible combinations of different electrolytes and/or concentrations in contact in with the first and second electrode.

In some examples, the first and/or the second electrode comprises an all-solid structure.

The term “all-solid structure” as used herein may refer to a solid structure, having three dimensions as a geometrical body, which generally maintains its size and shape at least under the usual operating conditions of a redox battery (a temperature ranging from −20° C. to 90° C., a humidity ranging from 0% relative humidity to aqueous environment etc.). The “all-solid structure” can be a porous structure or a dense structure. By providing a redox battery unit cell with an electrode comprising an all-solid structure, various geometric features can be implemented into the electrode thus allowing a stable, durable and more versatile and generally improved charge distribution and transfer, as well as electrolyte distribution. Both, the first and/or the second electrode can comprise an all-solid structure.

Alternatively, the first electrode can comprise an all-solid structure and the second electrode can comprise a fluid (or vice versa) as discussed above.

In some examples, the first flow field forms an integral part of the first electrode.

The term “integral part” as used herein may define that a component or technical feature (such as the flow field) is integrally fixed to a different component or technical feature (such as the electrode). If the first flow field forms an integral part of the first electrode, these two technical features are present in the redox battery unit cell as a single component, which provides electric conductivity and which provides distribution of the electrolyte. In order to provide a first flow field as an integral part of the first electrode, the flow field can be provided as a separate solid component fixed to the electrode or the electrode and flow field can be manufactured integrally as one piece. In the latter case, the charge transfer between the flow field and electrode is optimized by nullifying charge-transfer resistance from Mott-Schottky contacts, grain boundaries etc. In redox batteries of the prior art, a carbon cloth is often used in order to provide a distribution of the electrolyte. However, by using a carbon cloth having low conductivity and uncontrolled electrolyte distribution, efficient charge transfer is greatly hindered and thus the energetic efficiency of the battery is greatly reduced. By providing an electrode comprising a flow field as an integral part, the redox battery unit cell of the present disclosure can be structurally simplified in comparison to the electrochemical devices known in the prior art.

In some examples, the first flow field is thus an integral part of the first electrode. Similarly, the second flow field can be an integral part of the second electrode as discussed subsequently. In some examples, the electrode is thus a monolithic component of the redox battery unit cell. That is, the flow field can be a monolithic component or can be formed as a monolithic component, thereby providing a monolithic assembly of electrode and flow field. In some examples, the redox battery unit cell comprises thus a first monolithic electrode (formed of a single work-piece) which has the flow field integrated into the electrode.

In some examples, the first electrode is thus formed essentially of one piece (monolithic electrode) and includes the flow field in the one-pieced component. That is, the electrode can be in the form of a unitary or monolithic piece/component of the redox battery unit cell and includes the flow field as a structure that is integral (integrally formed) to the electrode. That is, the electrode (including the flow field) can be a unitary workpiece. Such a unitary workpiece as electrode can be in the form of a monolithic workpiece as discussed above. That is, the electrode can be seamless in the assembled redox battery unit cell.

The term ‘monolithic’ as used herein thus refers to an electrode comprising the flow filed as a unified structure. In some examples, the electrode can be provided as a monolithic cuboid or plate, wherein the flow field structure is milled in/molded in/formed in the cuboid structure. The flow field can be incorporated as a relief (diminution) into the monolithic electrode.

That is, the structure is being characterized as being a unified entity formed from a single piece or a coherent assembly of interconnected parts, emphasizing the indivisibility of the two functions (electrode and flow filed) provided by the monolithic structure in the overall system. The structure can thus have an integral composition, indicating that it is composed of a singular material or a homogenous combination of materials forming a cohesive and inseparable unit. Such a single-piece design of the electrode+flow field can thus highlight the absence of separate components or the need for assembly, reinforcing the concept of a monolithic entity. In addition to the pre-formed electrode+flow field structure, the indivisibility of the structure emphasizes that it is configured in such a way that it cannot be easily separated into distinct parts without compromising its functionality. Such a coherent assembly can be characterized by having various components seamlessly integrated to function as a single, cohesive entity. The electrode and flow field can thus, in some examples, be unified to provide an excellent electrolyte distribution while having superior electronic conductivity due to the boundary-free and thus practically non-resistant flow of current.

Specifically, forming a monolithic (seamless) electrode including the flow field as a component can be prepared from various electronically conductive materials as further discussed subsequently. In some examples, the monolithic electrode which includes the flow field as an integral feature is formed from monolithic aluminum, monolithic carbon-coated aluminum, monolithic copper, monolithic carbon-coated copper, monolithic nickel, monolithic carbon-coated-nickel, monolithic iron, monolithic carbon-coated iron, monolithic steel, monolithic carbon-coated steel, monolithic stainless steel, monolithic carbon-coated stainless steel, monolithic carbon, monolithic glassy carbon, monolithic graphite, monolithic titan, monolithic tantalum, monolithic carbon-coated titan, monolithic carbon-coated tantalum, monolithic metal-carbide-coated titan, monolithic metal-carbide coated tantalum, preferably from the group consisting of monolithic graphite, monolithic aluminum, monolithic carbon-coated aluminum, monolithic copper and monolithic carbon-coated copper.

Various methods can be used to prepare integral flow fields and/or monolithic electrodes comprising the flow field including but not limited to the following. By incorporating an electrode comprising a flow field, the flow field structure can be implemented into the electrode pre-assembly of the redox battery unit cell. Thereby, combining (e.g. via pressing, compacting etc.) components of cell components in order to form the flow field is not necessary. Specifically, since such pressing or compacting steps can result in structural weak points of readily assembled cells, preforming the monolithic first electrode (optionally also the monolithic second electrode) provides the redox battery unit cell with structural integrity and reliability of the complete system which can furthermore be implemented and tested pre-assembly.

Creating a monolithic electrode structure involves forming a single, integrated piece without the need for assembly from multiple components (e.g. pressing, compacting, hot-pressing). Various methods can be employed to prepare monolithic electrode structures (including the flow field as an integral part) for use in redox flow batteries or other electrochemical devices.

In some examples, the first electrode comprising the first flow filed can thus be manufactured by shaping, molding, 3D printing, casting, foam formation, deposition methods, electrical discharge machining etc. The monolithic electrode can thus be a casted electrode, a molded electrode, a 3D-printed electrode, a deposited (electrodeposition, chemical vapor deposition) electrode etc. Methods for preparing such a monolithic structure that can be readily incorporated in a redox battery unit cell include:

Casting: In this method, a mixture of electrode materials is prepared in a liquid form, often a slurry or suspension. The liquid mixture is then poured or cast into a mold of the desired shape. Once the material solidifies, it forms a monolithic structure. After casting, post-processing steps like drying and curing may be applied.

Molding: Molding involves shaping a material into the desired form using a mold. The material, which can be a conductive material or a composite, is placed into the mold and subjected to pressure and/or heat to take on the mold's shape. The process can produce intricate and complex structures, providing control over the final shape of the monolithic electrode.

3D Printing (Additive Manufacturing): Additive manufacturing techniques, such as 3D printing, enable the layer-by-layer construction of three-dimensional structures. This method allows for precise control over the electrode's design and architecture. Various materials, including conductive materials or composites, can be used in 3D printing to create monolithic electrodes with specific geometries.

Foam Formation: Foaming methods involve creating a foam structure of the electrode material. This can be achieved by introducing a foaming agent or gas into a liquid mixture of electrode materials. The resulting foam can be shaped into the desired form and subsequently solidified, creating a monolithic structure with a porous and interconnected network.

Chemical Vapor Deposition (CVD): CVD is a method in which thin films of material are deposited onto a substrate through chemical reactions in the vapor phase. While this method is often used for coatings, it can also be adapted to form monolithic structures by depositing materials layer by layer to build up a cohesive structure.

Electrodeposition: Electrodeposition involves the electrochemical reduction of metal ions onto a conductive substrate. By controlling the deposition parameters, it is possible to build up a monolithic structure with a uniform distribution of the electrode material. This method is commonly used for metal-based electrodes.

Providing the flow field as an integral (one-pieced/monolithic) part of the electrode can thereby provide various technical advantages over redox battery unit cells comprising arrangements, wherein the flow field is formed when assembling and pressing (such as pressing/hot pressing) unit cells. In particular since established assembling methods (such a via pressing/hot-pressing fiber mats and conductive components) introduce physical and electrical boundaries and thus resistivity into the device, the flow of electrolytes and also current can thereby be greatly affected and the overall efficiency reduced. Furthermore, by providing a redox battery unit cell having a monolithic structure that is the electrode and the flow filed in combination allows for using various combination of materials in the cell since no (force or shear) impairing pressing or compacting step is required in the assembly in order to form a flow field structure adjacent to the electrode.

Further advantages resulting from using one-pieced flow-field/electrode components are discussed in the following.

Simplified Design and Manufacturing: Integrating the flow field into the electrode simplifies the overall design of the redox flow battery. This integration often leads to a more compact and streamlined system, reducing the number of separate components. A simplified design can simplify manufacturing processes, reduce assembly costs, and improve the overall reliability of the system.

Enhanced Structural Integrity: monolithic integration of the flow field into the electrode structure can enhance the structural integrity of the redox flow battery. This integration provides better support for the flow field, reducing the risk of mechanical failure or deformation. Improved structural integrity is crucial for maintaining the long-term reliability of the battery, especially in applications with dynamic environmental conditions.

Improved Electrical Conductivity: monolithic integration of the flow field with the electrode allows for better control over the electrical conductivity of the system. This is particularly important for ensuring efficient electron transfer during the electrochemical reactions. Enhanced electrical conductivity contributes to lower internal resistance, which is beneficial for achieving higher energy conversion efficiency and faster charge/discharge rates.

Optimized Flow Paths: monolithic integration allows for the optimization of flow paths within the electrode itself. This means that the design can be tailored to ensure that electrolyte flows uniformly across the entire electrode surface, maximizing the utilization of active materials. Well-optimized flow paths help prevent dead zones or areas of poor flow, promoting uniform electrochemical reactions.

Reduced System Complexity: monolithic integration of the flow field into the electrode reduces the number of separate components and connections within the redox flow battery. This reduction in complexity simplifies system maintenance, improves reliability, and makes the battery system more user-friendly. It also reduces the likelihood of potential failure points, contributing to the long-term stability of the system.

Improved Sealing and Leak Prevention: monolithic integration can facilitate better sealing between the flow field and the electrode. Effective sealing is critical to prevent electrolyte leaks, which can lead to safety hazards and compromise the overall performance of the redox flow battery. Integrated designs often offer better control over sealing mechanisms, enhancing the overall robustness of the system.

Optimal Electrolyte Management: monolithic integration allows for better management of the electrolyte within the electrode structure. This includes controlling the distribution, flow rate, and uniformity of the electrolyte. Optimal electrolyte management is crucial for maintaining the electrochemical performance of the redox flow battery and preventing issues such as uneven wear or degradation of the electrode materials.

In summary, making the flow field an integral part of the monolithic component of the electrode of a redox flow battery brings advantages related to simplified design, enhanced structural integrity, improved electrical conductivity, optimized flow paths, reduced system complexity, better sealing, and optimal electrolyte management. These advantages collectively contribute to a more efficient, reliable, and cost-effective energy storage system. Similarly, also the second flow field of the second electrode can be formed of a monolithic structure comprising electrode and flow field.

In some examples, the second flow field forms an integral part of the second electrode. As discussed for the first flow field of the first electrode, also the second electrode can be in the form of a monolithic component, i.e. a monolithic second electrode comprising the second flow field as an integral part. By providing a redox battery unit cell having a first electrode comprising a first flow field as a monolithic structure and having a second electrode comprising a second flow field as a monolithic structure can yield a synergism in adjusting the monolithic electrode+flow field structure of both sides of the redox battery unit cell.

Similar to the first electrode, also the second electrode can comprise a second flow field, wherein the second flow field forms an integral part of the second electrode. The second flow field of the second electrode is generally provided as an integral part thereof for the technical effects as discussed for the first electrode above.

In some examples, the first flow field and the second flow field are substantially symmetrical with respect to the membrane arranged between the first electrode and the second electrode.

The term “substantially symmetrical” as used herein with respect to the flow fields may refer to flow fields which are substantially symmetrical with respect to a line corresponding to or parallel to the membrane arranged between the first and second electrode. That is, the shape of the first and the second flow field can be of the same shape and size, wherein the first flow field is arranged closer to the membrane than the second flow field. Alternatively, the second flow field is arranged closer to the membrane than the first flow field. Alternatively, the first flow field is arranged substantially at the same distance to the membrane as the second flow field.

By providing a redox battery unit cell, wherein the first flow field and the second flow field are substantially symmetrical with respect to the membrane arranged between the first electrode and the second electrode, the structural stability and charge transfer of the redox battery unit cell can be increased. That is, by providing flow fields on both sides of the membranes, which are substantially symmetrical with respect to said membrane, structural deformation resulting from dissimilar electrolyte flow or pressure can be prevented. Furthermore, by providing flow fields on both sides of the membranes, which are substantially symmetrical, the charge transfer can be optimized. That is, by providing flow fields, wherein a fully charged first electrolyte flows symmetrically to a fully discharged second electrolyte, charge transfer between the two species via the membrane can be optimized.

In some examples, the first and/or second electrode comprises one or more components selected from the group consisting of aluminum, carbon-coated aluminum, copper, carbon-coated copper, nickel, carbon-coated-nickel, iron, carbon-coated iron, steel, carbon-coated steel, stainless steel, carbon-coated stainless steel, carbon, glassy carbon, graphite, preferably from the group consisting of graphite, aluminum, carbon-coated aluminum, copper and carbon-coated copper.

Generally, the first and/or second electrode can be of any electron-conducting material as discussed above. If the electrode comprises one or more of the above compounds, the conductivity of the electrodes is improved, while providing structural stability to the redox battery unit cell. Furthermore, graphite, aluminum, carbon-coated aluminum, copper and carbon-coated copper provide surprisingly good electric conductivity in combination with structural stability while avoiding cost-intensive materials. Carbon-coating can be provided on the metals using plasma-spraying, thermal-spraying, sputter-coating, pulsed laser deposition, sol-gel dip-coating, electrophoretic deposition, hot isostatic pressing, ion beam-assisted deposition or other known methods.

In some examples, the first electrode comprising the first flow field consists of graphite, aluminum, carbon-coated aluminum, copper or carbon-coated copper. In some examples, the second electrode comprising the second flow field consists of graphite, aluminum, carbon-coated aluminum, copper or carbon-coated copper.

Electrodes consisting of graphite, aluminum, carbon-coated aluminum, copper or carbon-coated copper provide excellent conductivity, charge-transfer properties as well as longevity by reducing or preventing electrode disintegration through possible reactions of the electrode with the electrolyte or other functional groups or absorbed species caused by possible contaminations. As a result, also the charge-discharge coulombic efficiency during cycling is improved.

In some examples, the membrane comprises one or more inorganic membranes, optionally ceramic or zeolitic membranes, or one or more organic membranes, optionally synthetic or natural polymer membranes.

The membrane can comprise one or more organic membranes, for example synthetic or natural polymer membranes.

A majority of industrial membranes consist of synthetic or natural polymers; membranes with both types of polymers are known as organic membranes. Examples of synthetic polymers include polytetrafluoroethylene (PTFE), polyamide-imide (PAI), and polyvinylidenedifluoride (PVDF) while natural polymers include rubber, wool, and cellulose as used in dialysis.

Artificial polymers can be synthesized by the polymerization of a monomer or copolymerization of two or more monomers. Polymerization can have three general configurations: linear chains such as polyethylene, branched chains such as polysulfone, and cross-linked structures such as phenol-formaldehyde. Linear-chained polymers are more soluble in organic solvents. They become pliable or moldable with increased temperature and are known as thermoplastic polymers. On the other hand, cross-linked polymers are almost insoluble in organic solvents. They do not soften with increased temperature and are known as thermosetting polymers.

Polymer selection must be based on compatibility with membrane fabrication technology and intended application use. For example, the polymer may require a low affinity toward the permeate, while it may need to withstand harsh cleaning conditions due to membrane fouling in other scenarios. Chain interactions, chain rigidity, functional group polarity, and stereoisomerism also need to be factored in when choosing the polymer and manufacturing organic membrane.

The membrane can comprise one or more inorganic membranes, for example ceramic or zeolitic membranes.

Ceramic membranes consist of metal (for example aluminum or titanium) and nonmetal (for example oxides, nitride, or carbide). They are generally used for highly acidic or basic environments due to inertness but are equally suitable for mildly acidic and mildly basic or neutral pH. A downside of ceramic membranes can be the sensitivity to temperature gradient, which can lead to membrane cracking.

Zeolite membranes are generally used in highly-selective gas separation due to highly uniform pore size but can equally be used as a membrane in liquid system such as a redox battery unit cell of the present disclosure. Few downsides of zeolite membranes include relatively low fluid flux and thicker layer requirements of the membrane to prevent cracks and pinholes.

In some examples, the membrane comprises one or more composite membranes, for example polyphosphate membranes. Polyphosphate membranes comprise an organic polymer and an inorganic phosphate compound, that is a polymer-phosphate composite membrane. Polyphosphate composites for membrane fabrication can be synthesized for example by reacting ammonium phosphate with silicon oxide in the presence of ammonia. An exemplary composite can comprise a compound with the sum formula NH₄PO₃/(NH₄)₂SiP₄O₁₃. Additional phosphate components such as NH₄PO₃ can also be present in the composite. Polyphosphate membranes are characterized by a very high ionic conductivity in humid atmosphere and in liquid and exhibit thermal stability up to at least 300° C. and chemical stability (for example for a pH ranging from 2 to 10). This makes it suitable for redox battery applications. The conductivity values of polyphosphate membranes can vary at least from 1.0×10⁻⁵ S cm⁻¹ at 50° C. to 1.0×10⁻² S cm⁻¹ at 300° C. in dry hydrogen during a heating cycle, and the conductivity values can vary at least from 5.0×10⁻² S cm⁻¹ at 100° C. to 5.0×10⁻¹ S cm⁻¹ at 300° C. in humid hydrogen atmosphere.

In some examples, the membrane is an ionic or non-ionic size-selective membrane having a pore size ranging from 5 Å to 100 Å, preferably ranging from 10 Å to 50 Å. The term “pore size” as used herein may refer to the effective pore diameter of one or more pores in the membrane. The pore size (or pore diameter) can be measured using gas porosimetry (gas adsorption) or mercury (intrusion) porosimetry. The selected pore size can be adjusted to suit the particular application/electrolyte. For example, the membrane can be selected for retaining particles, molecules or ions having a size of 1 nm, 2 nm, 5 nm, or 10 nm. The pore size can also be defined by the molecular-weight-cut-off (MWCO). That is, the membrane can also be selected such that the MWCO is 200 Dalton (corresponding to a pore size of about 1.3 nm), 400 Dalton (corresponding to a pore size of about 1.8 nm), 600 Dalton (corresponding to a pore size of about 2.1 nm), 1000 Dalton (corresponding to a pore size of about 2.7 nm), or greater than 2000 Dalton (corresponding to a pore size of greater than about 4.1 nm).

In some examples, the first flow field comprises one or more first inlets coupled to a first storage tank and/or one or more first outlets coupled to the first storage tank, wherein, preferably, the one or more first inlets of the first flow field are arranged substantially opposite to corresponding, respective ones of the one or more first outlets of the first flow field.

A fluid, such as the electrolyte, can be provided to the first flow field via one or more first inlets. The fluid can additionally or alternatively exit the first flow field through one or more first outlets. The first flow field is coupled via the one or more first inlets and one or more first outlets to a first storage tank. In the first storage tank, a first electrolyte can be provided. By providing one or more first inlets, inlet turbulences can be created in the first flow field. Such turbulence increases the flow velocity of the electrolyte inside the flow field. Increased flow velocity allows more charge carriers to be removed from or introduced into the electrolyte. Such increased flow velocity is particularly beneficial for reduction-oxidation species exhibiting fast charge transfer (for example by delocalization of the charge). Such turbulences can also be created by providing only one inlet but a plurality of outlets.

The one or more inlets and one or more outlets are preferably arranged substantially opposite to each other. By providing the one or more inlets and one or more outlets substantially on opposite sides of the flow field, a general macroscopic and controllable flow direction is created.

In some examples, the second flow field comprises one or more second inlets coupled to a second storage tank and/or one or more second outlets coupled to the second storage tank, wherein, preferably, the one or more second inlets of the second flow field are arranged substantially opposite to corresponding, respective ones of the one or more second outlets of the second flow field.

Similar to the first flow field, also with respect to the second flow field, a fluid such as the electrolyte can be provided to the second flow field via one or more second inlets. The fluid can additionally or alternatively exit the second flow field through one or more second outlets. The one or more second inlets and/or one or more second outlets of the second flow field are generally provided for the technical effects as discussed for the first flow field above. By providing also the second flow field with a one or more inlets and/or outlets, preferably arranged substantially opposite to each other, also the second electrolyte in the second flow field can be provided with turbulences as discussed above for the first flow field.

In some examples, the first flow field comprises a plurality of first inlets coupled to the first storage tank. By providing a plurality of first inlets, inlet turbulences in the first flow field can be created as discussed above in order to provide a characteristic stream velocity and turbulence intensity in the first flow field.

In some examples, the second flow field comprises a plurality of second inlets coupled to the second storage tank. By providing a plurality of second inlets, inlet turbulences in the second flow field can be created as discussed above in order to provide a characteristic stream velocity and turbulence intensity also in the second flow field.

In some examples, an inlet diameter of a first one of the first inlets is different from an inlet diameter of a second one of the first inlets and/or an inlet shape of the first one of the first inlets is different from an inlet shape of the second one of the first inlets. In some examples, an inlet diameter of a first one of the second inlets is different from an inlet diameter of a second one of the second inlets and/or an inlet shape of the first one of the second inlets is different from an inlet shape of the second one of the second inlets.

By providing inlets of different diameter and/or inlets of different shape, the turbulences and/or flow velocity created in the flow fields can be further tailored towards the used reduction-oxidation species ions in the first and second flow field.

In some examples, the first flow field comprises a plurality of first outlets coupled to the first storage tank. By providing a plurality of first outlets, inlet turbulences in the first flow field can be created as discussed above in order to provide a characteristic stream velocity and turbulence intensity in the first flow field.

In some examples, the second flow field comprises a plurality of second outlets coupled to the second storage tank. By providing a plurality of second outlets, inlet turbulences in the second flow field can be created as discussed above in order to provide a characteristic stream velocity and turbulence intensity also in the second flow field.

In some examples, an outlet diameter of a first one of the first outlets is different from an outlet diameter of a second one of the first outlets and/or an outlet shape of the first one of the first outlets is different from an outlet shape of the second one of the first outlets. In some examples, an outlet diameter of a first one of the second outlets is different from an outlet diameter of a second one of the second outlets and/or an outlet shape of the first one of the second outlets is different from an outlet shape of the second one of the second outlets.

By providing outlets of different diameter and/or outlets of different shape, the turbulences and/or flow velocity created in the flow field can be further tailored towards the used reduction-oxidation species ions in the first and/or second flow field.

In some examples, the inlet diameter of a first one of the first inlets is different from the outlet diameter of a first one of the first outlets. Furthermore, in some examples, the inlet shape of a first one of the first inlets is different from the outlet shape of a first one of the first outlets.

By providing a combination of first inlets and first outlets of different diameters and/or shapes, the flow volume of the fluid (such as electrolyte) can be controlled and thus the turbulence intensity in the first flow field can be adjusted and controlled without requiring additional cell infrastructure, such as a plurality of pumps, being integrated into the redox battery unit cell.

In some examples, the inlet diameter of a first one of the second inlets is different from the outlet diameter of a first one of the second outlets. Furthermore, in some examples, the inlet shape of a first one of the second inlets is different from the outlet shape of a first one of the second outlets.

By providing an inlet diameter and/or shape of a first one of the second inlets that is different from the outlet diameter of a first one of the second outlets, the technical effect discussed above for the first flow field can be achieved also for the second flow field.

In some examples, the first flow field comprises one or more channels separated by ribs for delivering a first electrolyte to the first electrode. In some examples, the second flow field comprises one or more channels separated by ribs for delivering a second electrolyte to the second electrode. By providing a first and/or a second flow field comprising channels, the fluid (such as the electrolyte) can be directed from the inlet through a fixed path in the flow field towards the outlet. Thereby, secondary flow directions can be provided within the overall flow direction from inlet to outlet within the flow field. By providing secondary flow directions by channels separated by ribs, the fluid follows a fixed path within the flow field and the complete geometry of the flow field can be fully utilized for charge transfer to or from the fluid (such as an electrolyte). Furthermore, the ribs forming the channel(s) provide the membrane-electrode assembly (MEA) with additional structural stability.

In some examples, the one or more channels form one or more of: a single serpentine structure, a multiple serpentine structure, a mixed serpentine structure, a parallel structure, a discontinuous structure, a pin type structure, a criss-cross structure, an interdigitated structure, a fractal interdigitated structure, a structure comprising asymmetric channels, a mesh structure, or a combination of two or more thereof.

A single serpentine structure is characterized in that one singular channel is provided from the inlet of the flow field to the outlet of the flow field, wherein the fluid flows in opposing directions from a first section of the serpentine to a second section of the serpentine. The singular serpentine channel can be in the form of a rectangular pattern, a circular pattern or a combination thereof. The single serpentine structure provides good fluid removal due to high flow velocity, a coverage of entire active area of the flow field. Depending on the specific geometry, a single serpentine structure can however result in reactants depletion along the length of the channels which can lead to uneven reduction-oxidation species distribution, high pressure drop, air oxidant issues, flooding danger at high current densities, or fluid build-up in bends which causes local current density reductions.

A multiple serpentine structure is characterized in that more than one singular channel is provided from the inlet of the flow field to the outlet of the flow field. The multiple serpentine channel can be in the form of a rectangular pattern, a circular pattern or a combination thereof. The multiple serpentine structure provides less pressure drop than single serpentine, adequate water/fluid removal, a coverage of entire active area of the flow field, higher performance as compared to a single serpentine structure and is considered as the optimum structure for large active areas.

Depending on the specific geometry, a multiple serpentine structure can, however, result in still relatively high pressure drop due to the length of channels and reduction-oxidation species depletion along the length of the channels leading to uneven reduction-oxidation species distribution in the flow field.

A mixed serpentine structure is characterized in that more than one single serpentine structure is provided within one flow field. For example, two or three single serpentine structures can be arranged next to each other in the flow field. The multiple serpentine structure provides less pressure drop than a single serpentine. Depending on the specific geometry, a multiple serpentine structure can provide a combination of the technical effects provided by the single serpentine structure and the multiple serpentine structure as discussed above in combination.

A parallel structure is characterized in that two or more channels coupled to the inlet are arranged substantially parallel to each other. Furthermore, the two or more channels are coupled to a first main channel connected to the inlet such that the fluid is flown in the main channel and subsequently through the parallel channels through the flow field. Furthermore, the two or more channels are coupled to a second main channel connected to the outlet such that the fluid flows through the parallel channels and subsequently through the second main channel through the flow field. In a preferred example, the parallel channels are arranged substantially perpendicular to the main channel. The parallel structure provides low pressure drop and uniform fluid distribution. Depending on the specific geometry, a parallel structure can, however, result in water blockage in a channel that results in an obstructed flow or a dead zone, inadequate water/fluid removal, inadequate pressure drop in near-outlet channels (channels geometrically close to the outlet) that results in non-uniform fluid flow, unstable voltage after extended operation, or low channel velocity.

A pin type structure is characterized in that a first plurality of channels in the flow field is arranged substantially parallel and in that a second plurality of channels in the flow field is also arranged substantially parallel, wherein the second plurality of channels is arranged substantially perpendicular with respect to the first plurality of channels. The remaining all-solid pin of the flow field thus form isolated pins. The pin structure provides low pressure drop and is suitable for high reactants flow rates with low utilization levels. Depending on the specific geometry, a pin type structure can, however, result in inhomogeneous reactants distribution, inhomogeneous water removal, or uneven current density distribution.

A criss-cross structure is characterized in that the structure is based on a parallel type structure with additional transversal channels. The combination of parallel and transversal channels allows for the fluid (e.g. gas) to merge with water droplets. The criss-cross structure provides improved fluid removal and overall similar advantages to a parallel structure. Depending on the specific geometry, a criss-cross structure can, however, also have similar disadvantages as the parallel structure discussed above.

An interdigitated (or discontinuous) structure is characterized in that the structure consist of two or more comb-shaped interdigitated finger-like solid ribs. The interdigitated structure provides good fluid/air removal due to using forced convection through fluid diffusion layer (FDL) instead of diffusion, good mass transfer, provides highest performance and provides homogeneous fluid distribution. Depending on the specific geometry, an interdigitated structure can, however, result in a high pressure drop, depending on FDL porosity and thickness and long-term damage to the FDL is possible.

A fractal interdigitated structure is characterized in that the structure comprises an interdigitated structured as discussed above, wherein the interdigitated structured is split in two or more fractal superstructures. The two or more superstructures can, for example, be arranged such that the flow field is split by a crossing mid-section from an inlet to an outlet of the flow field.

A structure comprising asymmetric channels is characterized in that the channels can be tapered, constricted and stepped. The structure comprising asymmetric channels can be tapered, constricted and stepped in combination. In the structure comprising asymmetric channels, one complete channel can be tapered, whereas a further channel can be constricted. Furthermore, an even further channel can be stepped. In the structure comprising asymmetric channels, a channel can be tapered in one section, constricted in a further section and stepped in a further section. The structure comprising one or more asymmetric channels provides improved performance under low voltage, improved mass transport and improved water/fluid removal. Depending on the specific geometry, a structure comprising one or more asymmetric channels can, however, result in a higher pressure drop or can be difficult to manufacture.

A mesh structure is characterized in that the channels form a network of evenly distributed openings of similar size. A mesh structure provides good performance under limited current range, low pressure drop and is controllable with respect to its contact area. Depending on the specific geometry, a mesh structure can, however, exhibit poor water/fluid removal, focused fluid distribution on the center and low distribution around the edges under high power output, furthermore identical porosity proper-ties can be difficult to manufacture, the mesh structure can exhibit corrosion issues, a high pressure drop and is possibly only applicable for small devices.

In some examples, the channels form a combination of a parallel structure and a serpentine structure. By combining a parallel structure and a serpentine structure formed by the channels in the flow field, the structure provides low pressure drop and uniform fluid distribution as well as good fluid removal due to high flow velocity, and coverage of the entire active area of the flow field.

In some examples, the one or more channels comprised in the first flow field exhibit, at least along a part of the respective channel, a rectangular shape or a squared shape or a parallelogram shape or a trapezoid shape or a triangular shape or a semicircular shape. Additionally or alternatively, in some examples, the one or more channels comprised in the second flow field exhibit, at least along a part of the respective channel, a rectangular shape or a squared shape or a parallelogram shape or a trapezoid shape or a triangular shape or a semicircular shape. Depending on the structure formed by the channels and the viscosity of the fluid, different shapes of the channels can be implemented in order to optimize charge transfer in the flow field.

In some examples, one or more channels comprised in the first flow field comprise one or more first microchannels and/or one or more first vortex promoters. Additionally or alternatively, in some examples, one or more channels comprised in the second flow field comprise one or more second microchannels and/or one or more second vortex promoters.

The term “microchannel” as used herein may refer to channels having a hydraulic diameter of below 1 mm, preferably in the range from 1 μm to 99 μm. The term “vortex promoter” as used herein (or vortex generator) may refer to a solid physical object that can be provided in the flow field in order to interact with the fluid to create turbulences. In addition to the geometric structure formed by the channels or the inlet and outlet configuration, turbulences and swirling can also be created or intensified in the flow fields by the addition of microchannels and/or vortex promoters in the first and/or second flow field.

In some examples, the one or more first and/or second vortex promoters comprise one or more of one or more drop-shaped obstacles, one or more circular obstacles, one or more twisted tapes, one or more coil-wires, one or more baffle types, one or more twisted tape-coiled wire, and one or more twisted tapes with one or more rods.

In some examples, a ratio of an average channel width of a channel comprised in the first flow field to an average rib width of a rib comprised in the first flow field ranges from 0.25 to 5.0, preferably from 0.4 to 2.0, further preferably from 0.5 to 1.5. In some examples, a ratio of an average channel width of a channel comprised in the second flow field to an average rib width of a rib comprised in the second flow field ranges from 0.25 to 5.0, preferably from 0.4 to 2.0, further preferably from 0.5 to 1.5.

The one or more channels in the first and second flow fields are separated by ribs as discussed above. The ribs are formed of a solid structure of the flow field as a part of the electrode. By adjusting the ratio of channel to rib, the flow field can be optimized with respect to the amount of fluid in the flow field, the flow velocity and the structural stability of the redox battery unit cell. That is, if the ratio of an average channel width of a channel comprised in the first flow field to an average rib width of a rib comprised in the first flow field is close to the lower limit of 0.25, the rib surrounding the channel is wider (on average) in comparison to the channel surrounded by the rib. In this case, the mechanical stability of the cell is maximized. On the other hand, if the ratio of an average channel width of a channel comprised in the first flow field to an average rib width of a rib comprised in the first flow field is close to the upper limit of 5.0, the rib surrounding the channel is narrower (on average) in comparison to the channel surrounded by the rib. Thereby, the amount of fluid in the flow field and thus the possible maximum charge transferred is maximized.

In some examples, an average channel width of a channel comprised in the first flow field ranges from 1.0 to 5.0 mm, preferably from 2.0 to 4.0 mm, wherein an average channel height of the channel comprised in the first flow field ranges from 0.1 to 2.0 mm, preferably from 0.5 to 1.0 mm, and wherein an average rib width of a rib comprised in the first flow field ranges from 0.5 to 1.5 mm, preferably from 0.75 to 1.25 mm. Additionally or alternatively, in some examples, an average channel width of a channel comprised in the second flow field ranges from 1.0 to 5.0 mm, preferably from 2.0 to 4.0 mm, wherein an average channel height of the channel comprised in the second flow field ranges from 0.1 to 2.0 mm, preferably from 0.5 to 1.0 mm, and wherein an average rib width of a rib comprised in the second flow field ranges from 0.5 to 1.5 mm, preferably from 0.75 to 1.25 mm.

Similar to the ratio of ribs and channels in the fuel cell, the mechanical stability and amount of fluid in the flow field can be adjusted and optimized by adjusting the absolute width and height of the channels and ribs.

In some examples, a first flow path, defined by the first flow field, of a first electrolyte in the first flow field of the first electrode and a second flow path, defined by the second flow field, of a second electrolyte in the second flow field of the second electrode are substantially parallel to each other.

By providing a flow path, as generally defined by the overall flow direction of the fluid in the flow field from the one or more inlets to the one or more outlets, which is substantially parallel in the first and second flow field, the charge transfer can be optimized.

In some examples, the first storage tank contains at least a first electrolyte having a pH value from pH=2 to pH=8, preferably from pH=2 to pH=5, further preferably from pH=3.5 to pH=4.5. In some examples, the first electrolyte has a pH value of 4.0±0.2. Additionally or alternatively, in some examples, the second storage tank contains at least a second electrolyte having a pH value from pH=2 to pH=8, preferably from pH=2 to pH=5, further preferably from pH=3.5 to pH=4.5. In some examples, the first (and/or second) electrolyte has a pH value of 4.0±0.2.

The standard potential of many redox species is dependent inter alia on pH and opens the possibility for increasing the cell potential by pH tuning. That is, since anolytes and catholytes in redox batteries can be pH dependent with respect to the resulting voltage (as expressed by the Nernst equation), by providing a pH value in the above range, the cell voltage can be optimized while preventing energy loss through side reactions such as hydrogen evolution at the negative electrode. Furthermore, by providing a pH in the above ranges, corrosion and/or health concerns are avoided, thus allowing durable and non-hazardous operation of the redox battery unit cell.

In some examples, the first electrolyte comprises a first buffer system. Additionally or alternatively, in some examples, the second electrolyte comprises a second buffer system.

Side reactions and/or charge transfer can influence the pH of the electrolyte. In order to prevent a significant diversion of the pH and to provide a stable redox system over a plurality of redox cycles, a buffer system can be provided in the first and/or second electrolyte. Exemplary buffer systems include acetic acid/acetate buffer, carbonic acid, hydrogen carbonate buffer and dihydrogen phosphate/hydrogen phosphate buffer and combinations thereof.

In some examples, the first and/or second electrolyte comprises polyatomic ions, preferably polyatomic ions selected from the group consisting of vanadates, molybdates, tungstates, niobates, tantalates, manganates, ferrates, nickelates, and mixtures thereof, preferably in a concentration ranging from 0.1 M to 2.0 M.

Polyatomic ions according to the present disclosure are preferably polyoxymetallates. Polyoxymetallates (POMs) are polyatomic ions, usually anions, that consists of three or more transition metal oxyanions linked together by shared oxygen atoms to form closed 3-dimensional frameworks. The metal atoms can be of group 6 (Mo, W), group 5 (V, Nb, Ta), transition metals and Tc in their high oxidation states. POMs can be isopolymetalates, composed of only one kind of metal and oxide, and heteropolymetalates, composed of one metal, oxide, and a main group oxyanion. Polyatomic ions exhibit in comparison to monoatomic ions beneficial properties such as fast redox reactions, stable chemical properties, multi-electron reaction, good redox reversibility and low permeability. In particular due to the charge delocalization in the polyatomic ion, multiple electric charges can be swiftly and easily transferred from and to the polyatomic ions. The integration of a flow field into at least the first electrode then allows for efficient charge transfer from POMs in the electrolyte to the current collector when charging/discharging the battery.

In some examples, the cell provides a current density ranging from 0.1 A/cm² to 10 A/cm², preferably ranging from 0.1 A/cm² to 5 A/cm², further preferably ranging from 0.5 A/cm² to 2 A/cm².

By using for example polyatomic ions in the above concentrations, high current densities in the cell can be achieved. Furthermore, while regular planar electrodes are limited by their geometry and thus do not allow such high current densities, the integration of a flow field into at least one electrode is capable of transferring the charge efficiently to a current collector when discharging the battery.

In some examples, the second electrode comprises a fluid.

It has been discussed in detail above that the first and the second electrode can comprise an all-solid structure. However, the second electrode can alternatively comprise a fluid. The term “electrode” as used herein may generally refer to a physical object (such as a solid or fluid) capable of taking an electric current to or from a source of power. That is, the term “electrode” as used herein can refer to an electron-conducting solid but alternatively to an electron-conducting fluid. In structures in which the second electrode comprises a fluid, the first electrode can comprise the technical features as discussed above. Furthermore, while the charge transferred via the membrane arranged between the first and second electrode can be transferred from the first electrode comprising a first flow field (and an electrolyte distributed therethrough) to a second electrolyte, the charge can also be transferred from the first electrode to a fluid such as a gas. That is, the electrons provided from the first electrode during discharging can react with a gas at the second electrode. For example, by reacting oxygen (contained in surrounding air) with electrons provided by discharging the electrolyte of the first electrode, the oxygen can be reduced and hydroxy anions are generated. By providing a redox battery unit cell, wherein the second electrode comprises a fluid (optionally comprising air and/or oxygen), the overall volume of the battery can be reduced due to the omission of, for example, the second electrolyte, while the energy density of the battery can be maintained.

In some examples, the gas comprises air. In some examples, the gas comprises oxygen. By operating the redox battery unit cell with (ambient) air, the infrastructure surrounding the redox battery unit cell can be further simplified since no artificial gas transfer is required.

In a further aspect according to the present disclosure, there is provided a redox battery cell stack. The redox battery cell stack according to the present disclosure comprises one or more redox battery unit cells as defined in any one of the example implementations outlined throughout the present disclosure, wherein the stack further comprises one or more current collectors coupled to the first and/or second electrode of the one or more redox batteries.

In some examples, the stack further comprises a first pump for pumping a first electrolyte from a first storage tank to the first flow field of the first electrode.

In some examples, the stack further comprises a second pump for pumping a second electrolyte from a second storage tank to the second flow field of the second electrode.

### BRIEF DESCRIPTION OF THE DRAWINGS

Further aspects, details and advantages of the present disclosure will become apparent from the detailed description of exemplary embodiments below and from the drawings, wherein:

FIG. 1 shows an exemplary redox battery unit cell coupled to a first and second electrolyte storage tank for providing a first and second electrolyte.

FIG. 2 shows an exemplary redox battery unit cell coupled to a single electrolyte storage tank for providing an electrolyte to a single electrolyte.

FIG. 3A shows an exemplary single serpentine structure.

FIG. 3B shows an exemplary multiple serpentine structure.

FIG. 3C shows an exemplary mixed serpentine structure.

FIG. 4A shows an exemplary parallel structure.

FIG. 4B shows an exemplary discontinuous structure.

FIG. 5A shows an exemplary pin type structure.

FIG. 5B shows an exemplary criss-cross structure.

FIG. 6A shows an exemplary fractal interdigitated structure.

FIG. 6B shows an exemplary structure comprising asymmetric channels.

FIG. 6C shows an exemplary mesh structure.

FIG. 7 shows exemplary channel shapes.

FIG. 8 shows a Nyquist plot of a RFB with carbon felt and with an electrode comprising a flow field in IM NaCl at frequency range of 1 mHz to 1 MHz.

FIG. 9 shows a Bode plot of a RFB with carbon felt in IM NaCl at frequency range of 1 mHz to 1 MHz.

FIG. 10 shows a Bode plot of a RFB with an electrode comprising a flow field in IM NaCl at frequency range of 1 mHz to 1 MHz.

FIG. 11 shows a rate test for RFB on a cell at open circuit voltage of 0.95 V. IR-corrected discharge voltage and IR-corrected power density for cell with carbon felt and with an electrode comprising a flow field.

FIG. 12 shows a block diagram of an exemplary redox battery cell stack.

### DETAILED DESCRIPTION

In the following description, for purposes of explanation and not limitation, specific details are set forth in order to provide a thorough understanding of the present disclosure. It will be apparent to one of skill in the art that the present disclosure may be practiced in other embodiments that depart from these specific details.

Example implementations of a redox battery unit cell described herein allow for a wide range of reduction-oxidation species used in the redox electrolyte. By providing a first electrode comprising a flow field, higher current, current densities (e.g. up to 10 A/cm²) and thus power densities can be achieved provided by the unit cell or stacks comprising the cell.

Furthermore, the inclusion of the first flow field in the first electrode allows the omittance of additional carbon felt which is generally used in the prior art in order to distribute the electrolyte comprising redox active species.

In addition to the structural simplification of the system (by avoiding additional carbon felts or comparable components for electrolyte distribution), the inclusion of flow field in the electrode significantly reduces the required pump performance for circulation of electrolytes and thus reduces the overall power consumption of the cell.

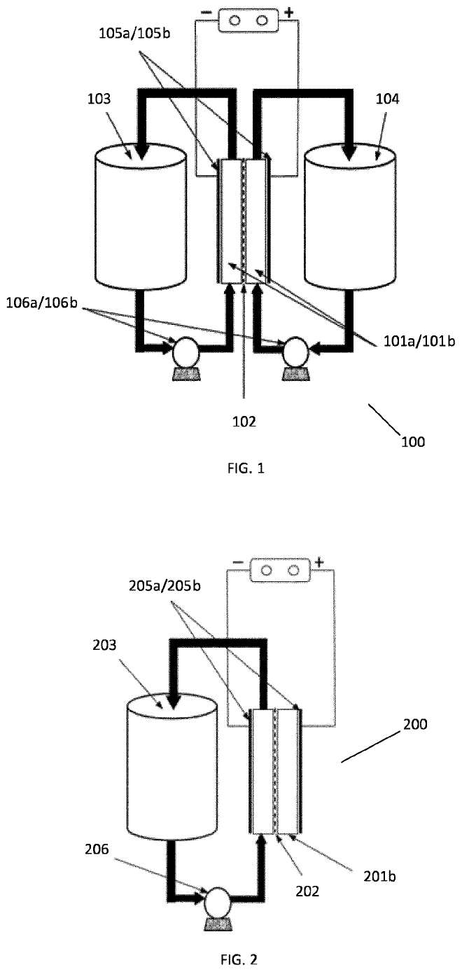

FIG. 1 shows an exemplary redox battery (100) with electrodes (101), wherein the first electrode (101a) comprises a flow field, and a membrane (102) arranged between the first electrode (101a) and the second electrode (101b). In the exemplary redox battery unit cell shown in FIG. 1, the flow field of the first electrode (101a) is coupled to a first storage tank (103) such as a negolyte tank and the second electrode (101b) is coupled to a second storage tank (104) such as a posolyte tank. Current collectors (105) are coupled to the first electrode (101a), i.e. a first current collector (105a), and to the second electrode (101b), i.e. a second current collector (105b). A first pump (106a) and a second pump (106b) are configured to provide the negolyte and the posolyte to the electrodes coupled thereto.

FIG. 2 shows a further exemplary redox battery (200), wherein the second electrode (201b) is an air-electrode. That is, while the part of the redox battery unit cell than can be coupled to the negolyte tank (203) is identical to the redox battery unit cell (100) shown in FIG. 1 (comprising a pump (206) and a membrane (202), the second electrode is an air electrode (201b) comprising a fluid in contact with a second solid electrode (which is a part of the second electrode (201b) and thus not shown as a separate feature in FIG. 2). That is, the charge transferred from the first electrode side via ions to the second electrode (201b) can be further transferred through an electrochemical reaction, such as with oxygen:

$$\frac{1}{2} {O}_{2} + 2 {H}^{+} + 2 {e}^{-} ↔ {H}_{2} O .$$

Current collectors (205a, 205b) are coupled to the first electrode and the second solid electrode of the air electrode (201b).

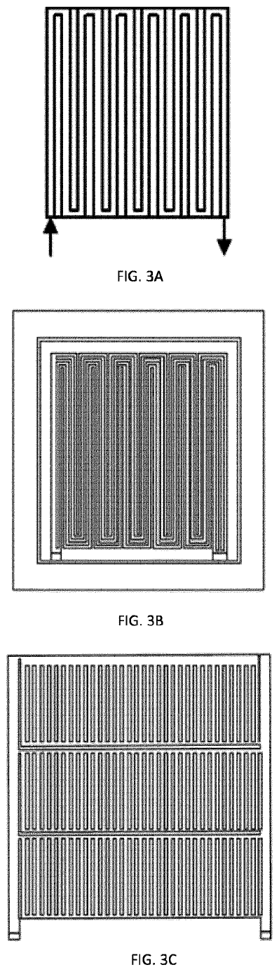

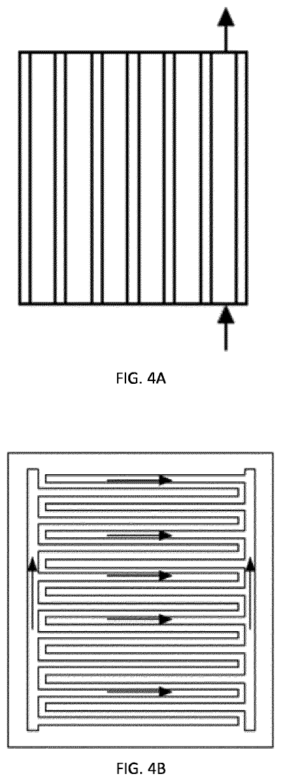

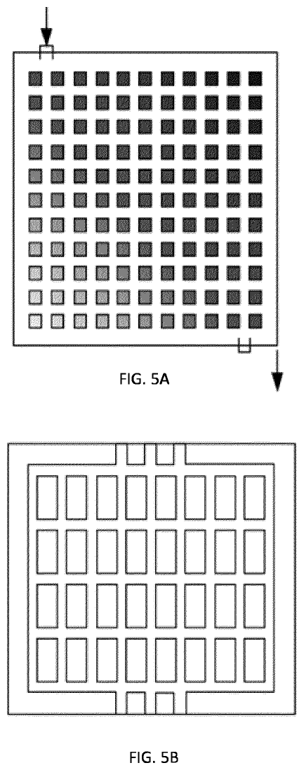

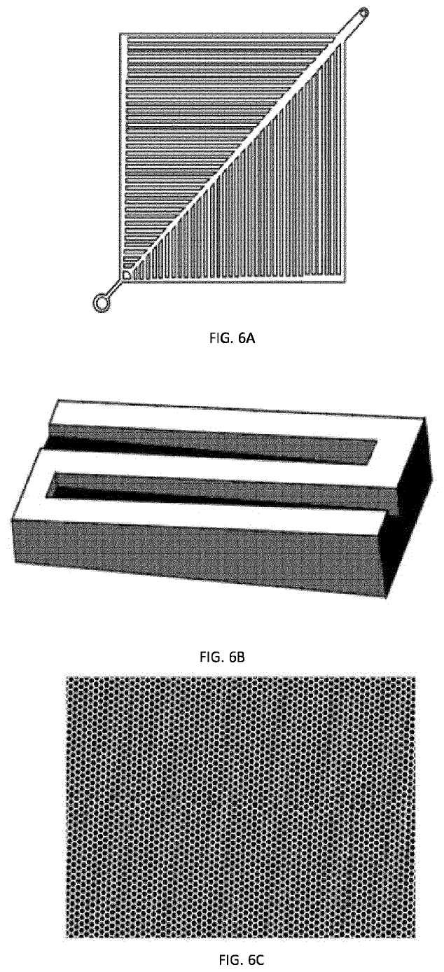

FIGS. 3 to 6 show flow field structures as discussed above, including single serpentine, multiple serpentine, mixed serpentine (FIG. 3A-3C), parallel, discontinuous (FIG. 4A, 4B), pin type, criss-cross (FIG. 5A, 5B), fractal interdigitated, comprising asymmetric channels, mesh type (FIG. 6A-6C) according to some example implementations as described herein. In selected structures, the flow direction of electrolyte or fluid to and from the flow field is indicated by arrows.

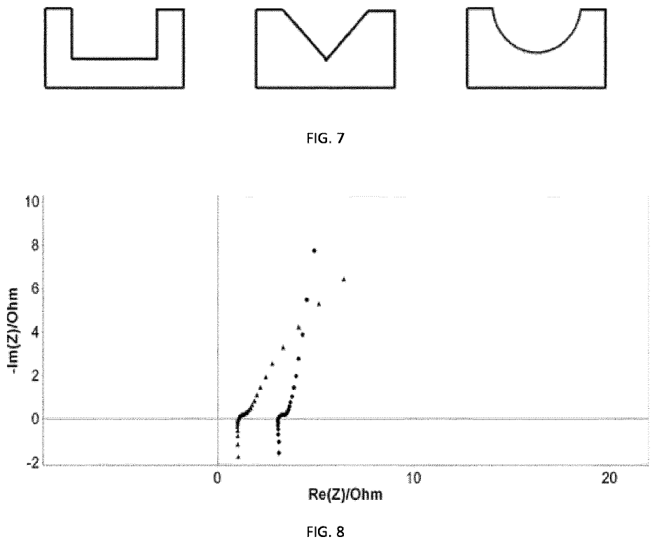

FIG. 7 shows selected channel shapes, including rectangular, triangular and semicircular according to some example implementations as described herein.

FIG. 8 show Nyquist plots of a redox battery unit cell according to the present disclosure (the first electrode comprising a flow field) in comparison to a redox battery unit cell comprising electrodes with no flow field but a carbon felt for electrolyte distribution in IM NaCl at frequency range of 1 mHz to 1 MHz. While the shape of the two plots is generally similar, the redox battery unit cell according to the present disclosure (shown by triangular measurement points) shows overall decreased Ohmic resistance in comparison to the redox battery unit cell comprising a carbon felt (shown by circular measurement points).

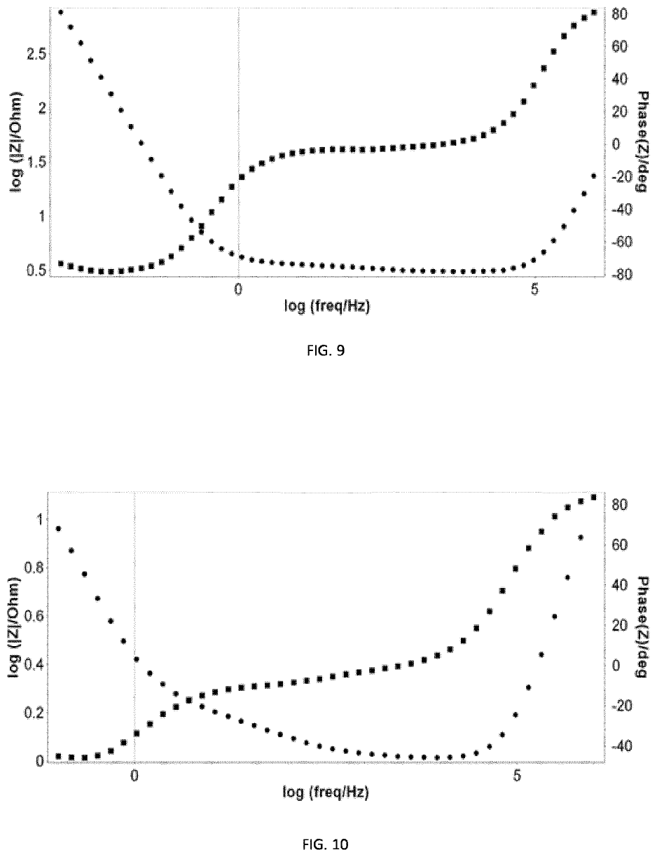

FIG. 9 shows a Bode plot of a redox battery unit cell comprising electrodes with no flow field but comprising a carbon felt for electrolyte distribution in IM NaCl at frequency range of 1 mHz to 1 MHz. In the bode plot, the frequency is plotted on the vertical, the electrical phase shift, and the absolute value of the impedance on the horizontal axis. In FIG. 9, circular measurement points of the carbon felt system represent the data of log (|Z|) vs. log (freq) and square measurement points represent the data of Phase(Z) vs. log (freq).

FIG. 10 shows a Bode plot of a redox battery unit cell according to the present disclosure (the first electrode comprising a flow field) in IM NaCl at frequency range of 1 mHz to 1 MHz. In FIG. 10, circular measurement points represent the data of log (|Z|) vs. log (freq) and square measurement points of the flow field system according to the present disclosure represent the data of Phase(Z) vs. log (freq).

Also the Bode plots of the two systems shows generally similar trends. However, similar as discussed for the Nyquist plots above, the overall resistance of the carbon felt system is greater as compared to the flow field system according to the present disclosure. In particular at low frequencies, the logarithmic resistance in the flow field system is more than halved. Without wishing to be bound by theory, it is assumed that the differences in the Nyquist and Bode plots result from additional resistances and/capacitances in the redox battery unit cell comprising a carbon felt. It is for example known that the transport properties of such carbon felts as generally used in the prior art are an important parameter as the transport resistance can form a significant parasitic power loss depending on the configuration of the redox battery unit cell.

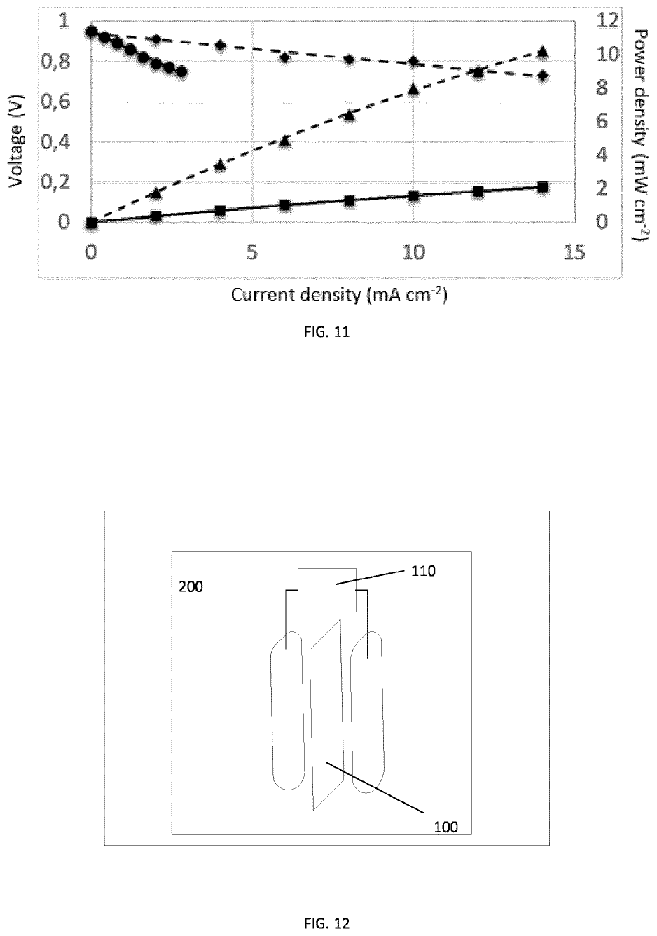

FIG. 11 shows the results of a rate test for RFB on a cell at open circuit voltage of 0.95 V. IR-corrected voltage of the carbon felt system is indicated by circular data points. IR-corrected voltage of the flow field system is indicated by diamond-shape data points. IR-corrected power density of the carbon felt system is indicated by square data points. IR-corrected power density of the flow field system is indicated by triangular data points. FIG. 11 shows that the flow field system provides surprisingly increased discharge voltage and surprisingly increased power density as compared to the carbon felt system.

FIG. 12 shows an exemplary redox battery cell stack 200. The exemplary stack shown in FIG. 12 comprises one redox battery unit cell and a current collector 110 electronically coupled to opposing sides of the redox battery unit cell.

It will be appreciated that the present disclosure has been described with reference to exemplary embodiments that may be varied in many aspects. As such, the present invention is only limited by the claims that follow.

1. A redox battery unit cell, comprising:
a first electrode,
a second electrode spaced apart from the first electrode, and
a membrane arranged between the first and the second electrode,
wherein the first electrode comprises a first flow field.

2. The redox battery unit cell according to claim 1, wherein the second electrode comprises a second flow field.

3. The redox battery unit cell according to claim 1 or 2, wherein the first and/or the second electrode comprises an all-solid structure.

4. The redox battery unit cell according to any one of claims 1 to 3, wherein the first flow field forms an integral part of the first electrode.

5. The redox battery unit cell according to any one of claims 1 to 4, in combination with claim 2, wherein the second flow field forms an integral part of the second electrode.

6. The redox battery unit cell according to any one of claims 1 to 5, in combination with claim 2, wherein the first flow field and the second flow field are substantially symmetrical with respect to the membrane arranged between the first electrode and the second electrode.

7. The redox battery unit cell according to any one of claims 1 to 6, wherein the first and/or second electrode comprises one or more components selected from the group consisting of aluminum, carbon-coated aluminum, copper, carbon-coated copper, nickel, carbon-coated-nickel, iron, carbon-coated iron, steel, carbon-coated steel, stainless steel, carbon-coated stainless steel, carbon, glassy carbon, graphite, preferably from the group consisting of graphite, aluminum, carbon-coated aluminum, copper and carbon-coated copper.

8. The redox battery unit cell according to claim 7, wherein the first electrode comprising the first flow field consists of graphite, aluminum, carbon-coated aluminum, copper or carbon-coated copper.

9. The redox battery unit cell according to claim 7 or 8, in combination with claim 2, wherein the second electrode comprising the second flow field consists of graphite, aluminum, carbon-coated aluminum, copper or carbon-coated copper.

10. The redox battery unit cell according to any one of claims 1 to 9, wherein the membrane comprises
one or more inorganic membranes, optionally metallic, ceramic or zeolitic membranes, or
one or more organic membranes, optionally synthetic or natural polymer membranes.

11. The redox battery unit cell according to any one of claims 1 to 9, wherein the membrane comprises one or more composite membranes, optionally polyphosphate membranes.

12. The redox battery unit cell according to any one of claims 1 to 11, wherein the membrane is an ionic or non-ionic size-selective membrane having a pore size ranging from 5 Å to 100 Å, preferably ranging from 10 Å to 50 Å.

13. The redox battery unit cell according to any one of claims 1 to 12, wherein the first flow field comprises one or more first inlets coupled to a first storage tank and/or one or more first outlets coupled to the first storage tank, wherein, preferably, the one or more first inlets of the first flow field are arranged substantially opposite to corresponding, respective ones of the one or more first outlets of the first flow field.

14. The redox battery unit cell according to any one of claims 1 to 13, in combination with claim 2, wherein the second flow field comprises one or more second inlets coupled to a second storage tank and/or one or more second outlets coupled to the second storage tank, wherein, preferably, the one or more second inlets of the second flow field are arranged substantially opposite to corresponding, respective ones of the one or more second outlets of the second flow field.

15. The redox battery unit cell according to claim 13 or 14, wherein the first flow field comprises a plurality of first inlets coupled to the first storage tank.

16. The redox battery unit cell according to claim 14, wherein the second flow field comprises a plurality of second inlets coupled to the second storage tank.

17. The redox battery unit cell according to claim 15, wherein an inlet diameter of a first one of the first inlets is different from an inlet diameter of a second one of the first inlets and/or an inlet shape of the first one of the first inlets is different from an inlet shape of the second one of the first inlets.

18. The redox battery unit cell according to claim 16 or 17, wherein an inlet diameter of a first one of the second inlets is different from an inlet diameter of a second one of the second inlets and/or an inlet shape of the first one of the second inlets is different from an inlet shape of the second one of the second inlets.

19. The redox battery unit cell according to any one of claims 13 to 18, wherein the first flow field comprises a plurality of first outlets coupled to the first storage tank.

20. The redox battery unit cell according to any one of claims 14 to 19, wherein the second flow field comprises a plurality of second outlets coupled to the second storage tank.

21. The redox battery unit cell according to claim 19 or 20, wherein an outlet diameter of a first one of the first outlets is different from an outlet diameter of a second one of the first outlets and/or an outlet shape of the first one of the first outlets is different from an outlet shape of the second one of the first outlets.

22. The redox battery unit cell according to claim 20 or 21, wherein an outlet diameter of a first one of the second outlets is different from an outlet diameter of a second one of the second outlets and/or an outlet shape of the first one of the second outlets is different from an outlet shape of the second one of the second outlets.

23. The redox battery unit cell according to any one of claims 19 to 22, wherein the inlet diameter of a first one of the first inlets is different from the outlet diameter of a first one of the first outlets.

24. The redox battery unit cell according to any one of claims 19 to 23, wherein the inlet shape of a first one of the first inlets is different from the outlet shape of a first one of the first outlets.

25. The redox battery unit cell according to any one of claims 20 to 24, wherein the inlet diameter of a first one of the second inlets is different from the outlet diameter of a first one of the second outlets.

26. The redox battery unit cell according to any one of claims 20 to 25, wherein the inlet shape of a first one of the second inlets is different from the outlet shape of a first one of the second outlets.

27. The redox battery unit cell according to any one of claims 1 to 26, wherein the first flow field comprises one or more channels separated by ribs for delivering a first electrolyte to the first electrode.

28. The redox battery unit cell according to claim 2, or any one of claims 3 to 27 in combination with claim 2, wherein the second flow field comprises one or more channels separated by ribs for delivering a second electrolyte to the second electrode.

29. The redox battery unit cell according to claim 27 or 28, wherein the one or more channels form one or more of:
a single serpentine structure,
a multiple serpentine structure,
a mixed serpentine structure,
a parallel structure,
a discontinuous structure,
a pin type structure,
a criss-cross structure,
an interdigitated structure,
a fractal interdigitated structure,
a structure comprising asymmetric channels,
a mesh structure,
or a combination of one or more thereof.

30. The redox battery unit cell according to claim 29, wherein the channels form a combination of a parallel structure and a serpentine structure.

31. The redox battery unit cell according to any one of claims 27 to 30, wherein the one or more channels comprised in the first flow field exhibit, at least along a part of the respective channel, a rectangular shape or a squared shape or a parallelogram shape or a trapezoid shape or a triangular shape or a semicircular shape.

32. The redox battery unit cell according to claim 28, or any one of claims 29 to 31 in combination with claim 28, wherein the one or more channels comprised in the second flow field exhibit, at least along a part of the respective channel, a rectangular shape or a squared shape or a parallelogram shape or a trapezoid shape or a triangular shape or a semicircular shape.

33. The redox battery unit cell according to any one of claims 27 to 32, wherein one or more channels comprised in the first flow field comprise one or more first microchannels and/or one or more first vortex promoters.

34. The redox battery unit cell according to claim 28, or any one of claims 29 to 33 in combination with claim 28, wherein one or more channels comprised in the second flow field comprise one or more second microchannels and/or one or more second vortex promoters.

35. The redox battery unit cell according to claim 33 or 34, wherein the one or more first and/or second vortex promoters comprise one or more of one or more drop-shaped obstacles, one or more circular obstacles, one or more twisted tapes, one or more coil-wires, one or more baffle types, one or more twisted tape-coiled wire, and one or more twisted tapes with one or more rods.

36. The redox battery unit cell according to any one of claims 27 to 35, wherein a ratio of an average channel width of a channel comprised in the first flow field to an average rib width of a rib comprised in the first flow field ranges from 0.25 to 5.0, preferably from 0.4 to 2.0, further preferably from 0.5 to 1.5.

37. The redox battery unit cell according to claim 28, or any one of claims 29 to 36 in combination with claim 28, wherein a ratio of an average channel width of a channel comprised in the second flow field to an average rib width of a rib comprised in the second flow field ranges from 0.25 to 5.0, preferably from 0.4 to 2.0, further preferably from 0.5 to 1.5.

38. The redox battery unit cell according to any one of claims 27 to 37, wherein an average channel width of a channel comprised in the first flow field ranges from 1.0 to 5.0 mm, preferably from 2.0 to 4.0 mm, wherein
an average channel height of the channel comprised in the first flow field ranges from 0.1 to 2.0 mm, preferably from 0.5 to 1.0 mm, and wherein
an average rib width of a rib comprised in the first flow field ranges from 0.5 to 1.5 mm, preferably from 0.75 to 1.25 mm.

39. The redox battery unit cell according to claim 28, or any one of claims 29 to 38 in combination with claim 28, wherein
an average channel width of a channel comprised in the second flow field ranges from 1.0 to 5.0 mm, preferably from 2.0 to 4.0 mm, wherein
an average channel height of the channel comprised in the second flow field ranges from 0.1 to 2.0 mm, preferably from 0.5 to 1.0 mm, and wherein
an average rib width of a rib comprised in the second flow field ranges from 0.5 to 1.5 mm, preferably from 0.75 to 1.25 mm.

40. The redox battery unit cell according to any one of claims 1 to 39, in combination with claim 2, wherein a first flow path, defined by the first flow field, of a first electrolyte in the first flow field of the first electrode and a second flow path, defined by the second flow field, of a second electrolyte in the second flow field of the second electrode are substantially parallel to each another.

41. The redox battery unit cell according to any one of claims 13 to 40, wherein the first storage tank contains at least a first electrolyte having a pH value from pH=2 to pH=8, preferably from pH=2 to pH=5, further preferably from pH=3.5 to pH=4.5.

42. The redox battery unit cell according to claim 14, or any one of claims 15 to 41 in combination with claim 14, wherein the second storage tank contains at least a second electrolyte having a pH value from pH=2 to pH=8, preferably from pH=2 to pH=5, further preferably from pH=3.5 to pH=4.5.

43. The redox battery unit cell according to claim 41 or 42, wherein the first electrolyte comprises a first buffer system.

44. The redox battery unit cell according to claim 42, or claim 43 in combination with claim 42, wherein the second electrolyte comprises a second buffer system.

45. The redox battery unit cell according to any one of claims 41 to 44, wherein the first and/or second electrolyte comprises polyatomic ions, preferably polyatomic ions selected from the group consisting of vanadates, molybdates, tungstates, niobates, tantalates, manganates, ferrates, nickelates, and mixtures thereof, preferably in a concentration ranging from 0.1 M to 2.0 M.

46. The redox battery unit cell according to any one of claims 1 to 45, wherein the cell provides a current density ranging from 0.1 A/cm² to 10 A/cm², preferably ranging from 0.1 A/cm² to 5 A/cm², further preferably ranging from 0.5 A/cm² to 2 A/cm².

47. The redox battery unit cell according to any one of claims 1 to 46, wherein the second electrode comprises a fluid.

48. The redox battery unit cell according to claim 47, wherein the fluid comprises a gas.

49. The redox battery unit cell according to claim 48, wherein the gas comprises air.

50. The redox battery unit cell according to claim 48 or 49, wherein the gas comprises oxygen.

51. A redox battery cell stack comprising one or more redox battery unit cells as defined in any one of the proceeding claims, wherein the stack further comprises one or more current collectors coupled to the first and/or second electrode of the one or more redox batteries.

52. The redox battery cell stack according to claim 51, wherein the stack further comprises a first pump for pumping a first electrolyte from a first storage tank to the first flow field of the first electrode.

53. The redox battery cell stack according to claim 51 or 52, in combination with claim 2, wherein the stack further comprises a second pump for pumping a second electrolyte from a second storage tank to the second flow field of the second electrode.
